(19) United States
(12) Patent Application Publication
(10) Pub. No.: US 2002/0169750 A1
(43) Pub. Date: Nov. 14, 2002

(54) Methods and systems for processing of forms from a central database

(76) Inventors: Robert G. Eaton JR., Glen Carbon, IL (US); Charles H. Devers, Kirkwood, MO (US)

Correspondence Address: JOHN S. BEULICK, C/O ARMSTRONG TEASDALE, LLP, ONE METROPOLITAN SQUARE, SUITE 2600, ST LOUIS, MO, 63102-2740, US

(21) Appl. No.: 10/125,672

(22) Filed: Apr. 18, 2002

Related U.S. Application Data
(60) Provisional application No. 60/284,909, filed on Apr. 19, 2001.

(51) Int. Cl. G06F 7/00

(52) U.S. Cl. 707/1

(57) ABSTRACT

A database management system is disclosed which includes a database server and at least one database configured to be accessed by the database server. The system also includes at least one computer configured to access the database server via the internet and at least one server configured to be accessed via at least one of the internet and a secure interface to the database server. The system is configured to capture and store, within the database, financial and demographic information on clients collected by registered subscribers. The database server is further configured to allow a registered subscriber to select any number of financial service providers and utilize the stored information to apply for any of a number of specific products offered by any selected financial services provider.

### CROSS REFERENCE TO RELATED APPLICATIONS

This application claims the benefit of U.S. Provisional Application No. 60/284,909, filed Apr. 19, 2001.

### BACKGROUND OF THE INVENTION

This invention relates generally to the processing of data, and more specifically to, processing systems and methods which provide paperless services and storage of data for financial transactions.

Many of the financial services industries, for example, insurance, are largely form based. That is, when a prospective client wishes to apply for an insurance policy, an agent, along with the clients help, has to fill out a paper application form, which is then sent to a home office of the insurance company for underwriting, and hopefully issuance of a new insurance policy. Some of these transactions have become computer based, and the applications are electronically uploaded to the home office. However, the computer has simply replaced the paper form, the agent or representative has to enter all of the pertinent data for the client. The computer based process simply eliminates the paper form and the mailing or faxing of the form to the home office.

Some applications are known which are a bit more sophisticated. For example, some insurance companies store databases of client (insured) and agent data. When a policy is added, updated, or another change is desired, the database can be accessed by the agent, and a large portion of the client data can be downloaded from the database. That is, the agent does not have to reenter certain known data, for example, name address, and social security number for a client again and again.

Certain insurance agents are considered to be captive agents. That is they only represent one insurance carrier. However, most agents are considered to be independent agents, and they may represent a number of companies. Further those companies may provide a large number of services ranging from simple auto insurance to various types of life insurance to investment services and retirement planning, which may include offering of regulated securities. Further, agents have to be registered within each state in which they conduct business, and the various states may require different information when a client is making any of the above described purchases.

Therefore, an agent is inundated with different forms, be they paper or computer based. Also, the various companies which an agent represents typically employ proprietary systems and no sharing of client information can take place between the proprietary systems. So, based on what products a client may wish to purchase, an agent is still typically required to enter client information, again and again.

### BRIEF DESCRIPTION OF THE INVENTION

In one aspect, a database management system is provided which comprises a database server, at least one database configured to be accessed by the database server, at least one computer configured to access the database server via the internet, and at least one server. The server is configured to be accessed, through known access methods, via at least one of the internet and a secure interface to the database server. The system is configured to capture and store, within the database, financial and demographic information on clients collected by registered subscribers. The database server is further configured to allow a registered subscriber to select any number of financial service providers and utilize the stored information within to apply for any of a number of specific products offered by any selected financial services provider.

In another aspect, a method for selling financial products using a database management system is provided. The system includes a database server and a database of client information. The provided method comprises logging in to the database management system, selecting a client profile, selecting a product, and determining if all information needed to complete an application form for the selected product is stored within the customer database for the selected client. If all the information needed is not within the database, the method continues by entering any information which is not stored within the customer database for the selected client, generating an application for the selected product using the stored and entered information, and storing the entered information for use in completing applications for additional financial products for other product types and other product vendors.

In still another aspect, a computer configured as a database server is provided. The computer is configured for internet access and to control data written to and read from at least one database. The computer is further configured to facilitate the storing, within the databases, information on clients collected by registered subscribers, the database including a listing of registered subscribers. The computer is configured to allow registered subscribers to connect via the internet and select any number of product types and vendors for the product types and utilize the client information to apply for any of a number of specific products offered by any selected vendor.

In yet another aspect, a method of doing business is provided. The method comprises storing, in a database, financial and demographic information for clients of registered subscribers, the information based upon at least one application for a financial services product, from at least one financial services provider and retrieving, from the database, the financial and demographic information for a client which is required to complete an application for any additional financial services product offered through the registered subscriber, the financial services provider selected being the same or different than the provider for the previous application. Continuing, the method further comprises formatting the retrieved information in a format acceptable for transmission to the selected financial services provider and transmitting the formatted information to the financial services provider, as well as to the subscriber for their own use.

### BRIEF DESCRIPTION OF THE DRAWINGS

FIG. 1 is a system diagram.

FIG. 2 is a flow diagram illustrating a virtual assistant process.

FIG. 3 is a continuation of the flow diagram of FIG. 2.

FIG. 4 is a continuation of the flow diagram of FIG. 3.

FIG. 5 is an example home page for accessing the virtual assistant process of FIGS. 2-4.

FIG. 6A is a page illustrating a profile for a client of a paid subscription user.

FIG. 6B is a page listing the clients of a paid subscription user.

FIG. 6C is a page illustrating selections for updating a client profile.

FIG. 7 is a page illustrating a vendors list for a selected product type for a paid subscription user.

FIG. 8 is a page illustrating how a paid subscription user can select products from a selected vendor.

FIG. 9 is a page illustrating which forms are required and optional for a selected product from a selected vendor.

FIG. 10 is a page illustrating which of the selected forms from FIG. 9 can be completed utilizing stored client data.

### DETAILED DESCRIPTION OF THE INVENTION

The features and principles of the present invention will now be described relative to an exemplary embodiment thereof. It will be apparent to those skilled in the art that numerous variations or modifications may be made to the exemplary embodiment without departing from the spirit and scope of the present invention. The system and method are not limited to the specific embodiments described herein. Components of each system and method can be practiced independent and separate from other components and methods. Each system and method also can be used in combination with other components and methods.

Referred to herein is a virtual assistant which is, in one embodiment, a hub to a suite of programs further described herein, although not necessarily described as programs. The virtual assistant includes an advanced database management system which captures, in a centralized database and in one embodiment, pertinent financial and demographic information collected by independent financial consultants. The database allows the independent financial consultants to select any number of financial services, including, but not limited to, mortgage products, life and health insurance policies, annuities, mutual funds and similar financial products, including property casualty insurance products. Upon selection of a product, the virtual assistant will cause needed information for a specific product application to be automatically compiled from the database, and request any additional information needed for the product application which is not already included within the database. The newly added information will also become a part of the database, since that particular and newly entered information may be required for future new product purchases, for example, insurance applications. Therefore, the virtual assistant provides an automated mechanism for the completion of what is sometimes referred to as the “paperwork” required to make applications for any one or more of the above listed products. The above listed applications should not be considered limiting, in that the technology may have further applications in other fields, for example, medical claims processing and loan processing.

The database management system packages the information, both the newly entered and that retrieved from the database, and sends it to a party, for example an insurance carrier, in the form or format that they request. Some typical formats include a formatted data stream, encrypted e-mail, encrypted zip file, or a fax document. For product applications that require a signed original or printed copies for the client (insurance applicant), the database management system completes the application forms for any given product using an on-line forms completion technology that meshes the client financial information into the requisite financial application forms for any of a number of financial service providers. The database management system therefore meets requirements of any given financial services provider, including those that require manual signatures.

In one embodiment, an interface to the virtual assistant and the rest of the database management system is achieved through an Internet web site, sometimes referred to as a homepage, by registered subscribers, who are typically representatives for one or more of the financial services companies that offer the services which are listed above. The below described system therefore allows an independent financial services professional, (i.e. the registered subscriber), to maintain all of his or her client's personal and confidential financial records in a centralized database which also maintains the data formatting requirements for a number of financial services providers. In one embodiment, only the registered subscriber for a particular client can gain access to that client's data, unless such access shall further provide access to a specifically described 3_{rd} party that might, for example, include a statutory, a regulatory, or a contractually agreed-upon party.

The system includes security provisions that ensure that all data transmissions are maintained in a secure environment. Any printed output of the financial services forms is likewise transmitted back to the registered subscriber in a highly secure network environment to ensure that a data packet representative of the final product cannot be hacked or inadvertently transmitted to the wrong end-user. Should a transmission to a wrong end-user occur, the data packet cannot be opened or viewed, which is an important consideration for complying with various confidential personal data regulations under existing federal law, including the Graham-Leach Act and Health Information Personal Privacy Act (HIPPA).

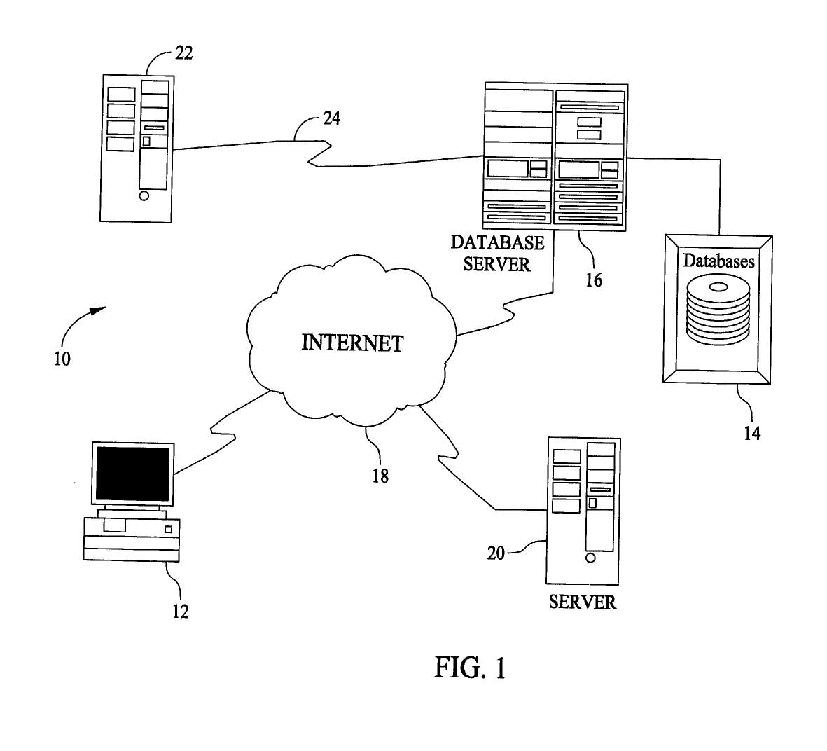

FIG. 1 is one embodiment of a database management system 10 which is configured to provide the above described functionalities. System 10 includes a registered subscriber computer 12, databases 14, and a database server 16. Computer 12 is able to access database server 16, and therefore databases 14, via the Internet 18. As is further described below, a server 20, for example, located at a provider of insurance products, is also connected to Internet 18. The connection of server 20 to Internet 18 provides a mechanism for communications between computer 12 and server 20, and database server 16 and server 20 as further described in the methods below. A provider system 22 is also shown in FIG. 1. Provider system 22 is communicatively connected to database server 16 utilizing a secure interface 24. Provider system 22 includes the functionality of server 20, except that provider system 22 is not Internet based. In one embodiment, database server 16 is located on a fiber optic or other alternative large broadband internet network such as a satellite transmission network or other high capacity network.

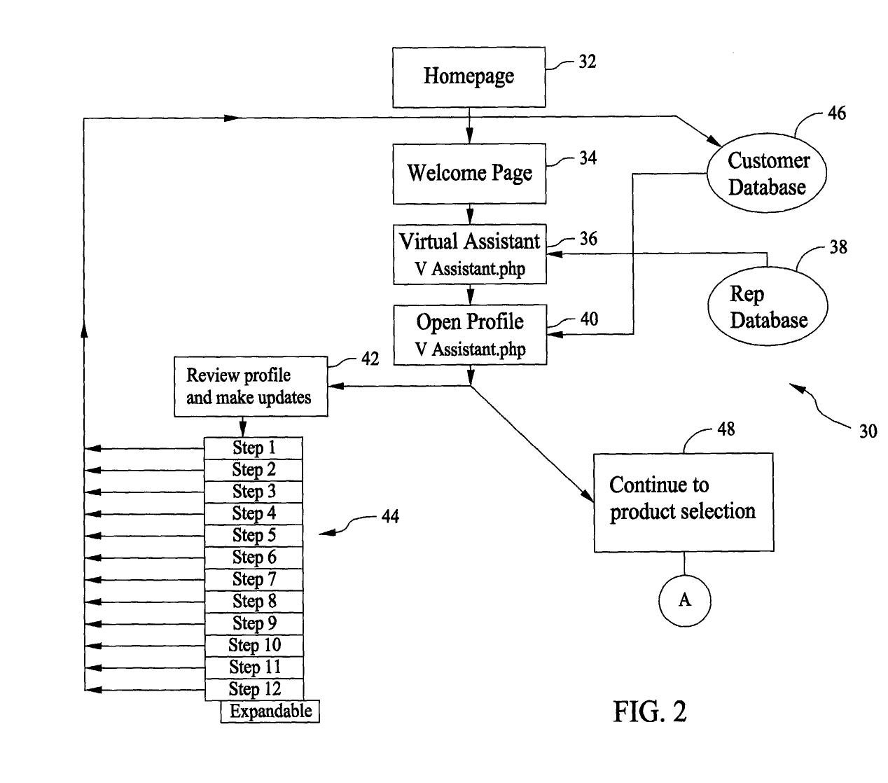

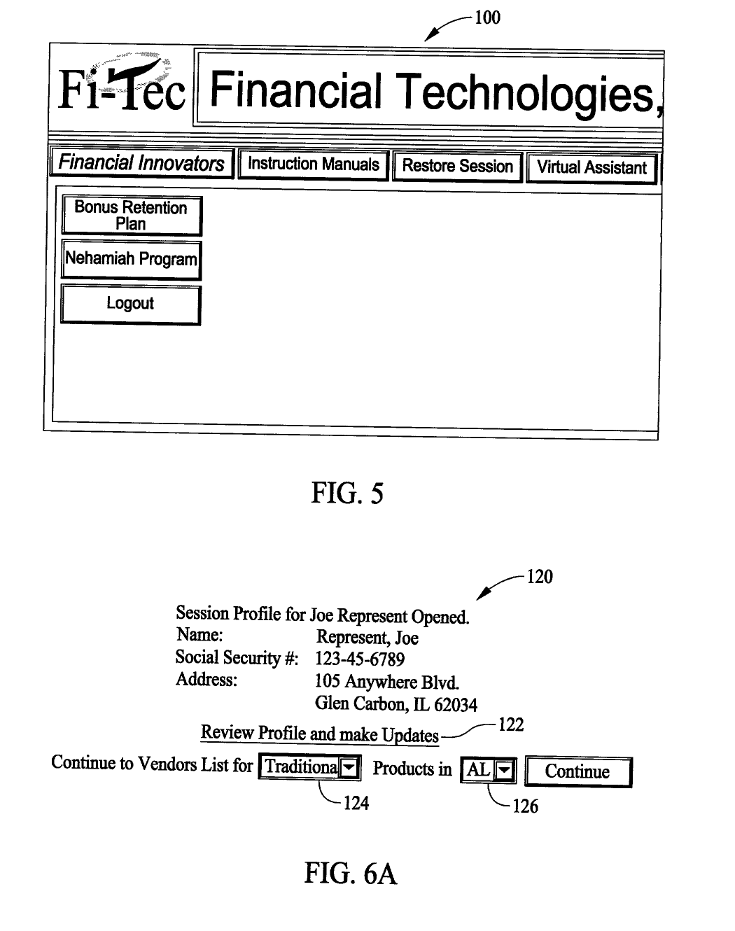

FIG. 2 is flow diagram 30 illustrating a virtual assistant process within the above described database management system 10. A registered subscriber, often referred to herein as a paid subscription user or PSU, accesses 32 a homepage which provides an entry point to database management system 10. The homepage provides an opportunity for the PSU to log in, after selection of a virtual assistant link (shown in FIG. 5). When the PSU logs in using the internet-based homepage, software within database server 16 examines information pertaining to the PSU which is stored within database 14 (shown in FIG. 1) to determine whether the PSU has paid subscription fees through the current period and what specific product platforms the PSU has paid subscription fees to use. If the subscription fees are paid, a session is opened for the PSU. The product check is performed against a master PSU database, within databases 14, that contains an inventory of all states and financial products for which the PSU is licensed to conduct business. The master PSU database further contains subscription data for the PSU. For example, if the PSU is a mortgage broker, they would not subscribe to an insurance support product, while such an insurance support product would probably be the product of choice for a PSU who is an independent insurance agent.

Once the determinations regarding the PSU have been made, database server 16 causes a welcome page to be displayed 34 at computer 12 of the PSU. From the welcome page, the PSU is able to select 36 a virtual assistant. The virtual assistant, upon selection, retrieves a table of clients for the PSU from representative database 38, which is included within databases 14. The PSU is able to select a client from the listing of clients, thereby causing a profile for the selected client to be opened 40. Once the PSU has opened 40 a profile for a client, then database server 16 causes a client screen to be displayed at PSUs computer 12, the screen is sometimes referred to as a Virtual Assistant Profile Screen.

From the Virtual Assistant Profile Screen the PSU may determine that a review profile and make update session should be selected 42. Such a selection would be typical if a long time had passed since a client/customer had met with the PSU or there had been a material change in the affairs of the PSU's client. The virtual assistant is configured to open 44 a series of fields to allows the PSU to update the profile of the client. Such updates are then stored in customer database 46, which is also within databases 14. The updates may be updates to previously stored data, or new data. Updating the client profile is an expandable process, meaning that additional client profile fields (or “steps”, as depicted in the FIG. 2) may be added at a future time, without any substantial or significant alterations to the database server 16. The purpose of the fields is to allow the PSU to create a complete economic, financial, health, and credit profile of each individual client of the PSU within customer database 46. For example, a PSU desiring to write a policy of health insurance might need applicable medical information that profiles the potential client according to the needs of a health insurer. Had the client previously purchased annuities from the PSU, an up-date for the health insurance application would be cumulative to the presently existing data within database 46.

The information needed for the health insurance application may not currently be included within customer database 46. However, at least a portion of the data needed for the health insurance is available from customer database 46 based on the previous annuities purchase. The remaining information needed for the health insurance is, upon entry, added to customer database 46 through utilization of the virtual assistant. A sum total of all information from the client, from the annuities purchase and the health insurance, is now stored in customer database 46 and is available to the PSU for future purchases of other products, and will require less, or possibly even no data entry by the PSU since the data that has been collected may meet the needs of any new or added financial product or service. Updating a client profile creates a register of activity for the events which have taken place during the session. Therefore, customer database 46 is dynamically updated while a running log is maintained for all activity that takes place on any PSU client file within customer database 46.

The profiles for each client correspond to information that, at least in some known systems, would typically be maintained by the PSU in a paper-based file for use by a PSU in meeting the service needs of a client for any given financial product.

Once the PSU has determined that the client's profile is properly updated, the PSU exits the review profile and make updates session, and the PSU is again presented with a screen for opening 40 a profile. The act of ending the review profile and make updates session has an effect of updating customer database 46. Customer database 46 is the repository of all client profiles for all PSU's using database management system 10. Customer database 46, in one embodiment, is accessed by a PSU solely and only for those specific clients under the direct control of the PSU. In such an embodiment, the PSU cannot access any other PSU client profiles despite the fact that all client profiles are held in a single, common database, that is customer database 46.

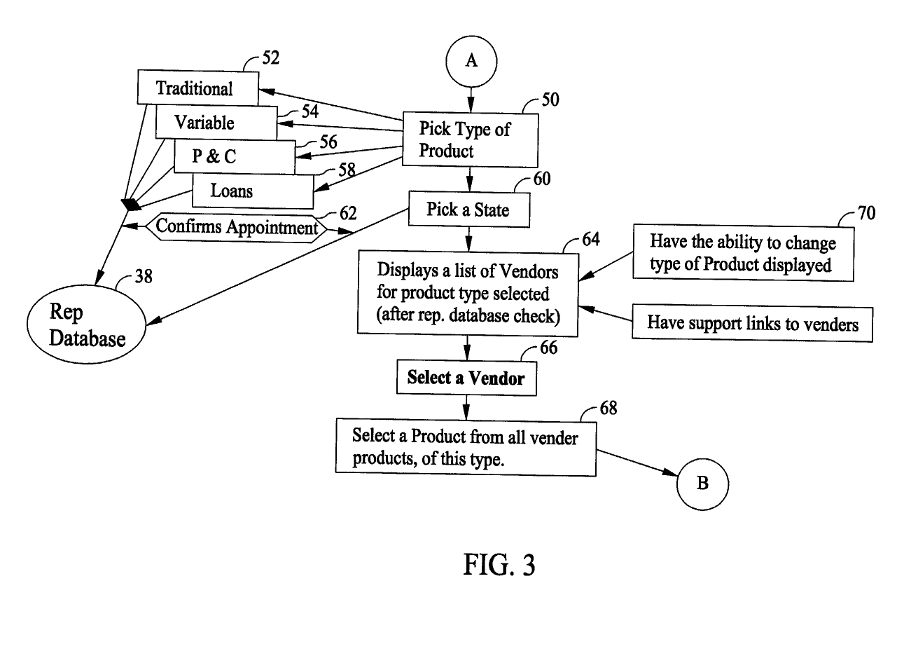

Within the open profile screen, the PSU is prompted 48 to select a product type. Product types include insurance, in one embodiment, inclusive of traditional, variable, property and casualty products, and loans. Although the product types refer to insurance type products, however the scope should not be construed to be so limited. Referring to FIG. 3, the PSU selects 50 a product type. In a specific embodiment, products are selected using drop down box or pull down menu as is well known in the art. As stated above, the choices, or categories, allowed in the embodiment shown are, traditional 52, variable 54, property and casualty (P&C) 56, and loans 58. These categories are generally aligned with the financial products that require specific licensure in order to be offered for sale by a representative, agent, marketing person, or loan originator such as the PSU.

Upon selection 50 by the PSU of one of the categories, database server 16 is configured to examine data within representative database 38 to determine whether the PSU has access to the type of product for which access has been requested. A recognition by database server 16 that a PSU does, in fact, have access to the categorical selection next results in an internal recognition of financial product vendors for which the PSU is either licensed to sell or for which the PSU is otherwise authorized to sell. The PSU is also presented with a selection 60, for example, a pull down menu that contains a listing of all 50 states. The PSU then selects 60 a state from the pull down menu that corresponds to the state in which a client's application must, for regulatory or other purposes, be taken for the contemplated product purchase. Again, database server 16 makes an internal review of representative database 38 to confirm 62 whether the PSU is licensed within the state which has been selected 60 for the product that previously was selected 50. For example, the check determines whether the PSU might offer a specific insurance company product for a specific state. The product offerings presented to the PSU are a direct result of the PSU's licensing and appointments to do business in any given state.

In one embodiment, representative database 38 and customer database 46 are under exclusive control of the provider of database server 16, and the information contained within cannot be accessed, modified or deleted by any other party.

Once database server 16 has verified the PSU is licensed for the selected 50 product type in the selected 60 state, database server 16 causes to be displayed on the PSUs computer 12 a screen that displays 64 a list of vendors for product type selected, for example, Company, A, Company B, and Company C. (see also Figure below). In one embodiment, should the PSU wish to modify the selection 50 of a product type, the page which displays the list of vendors is configured to allow the PSU to modify such a selection. In a specific embodiment, the PSU may access a listing of all product types available for selection through a pull down menu. In another specific embodiment, a choice by the PSU to amend the product type selected results in database server 16 forcing the PSU to reopen the customers profile and repeat the selections of a product and a state as outlined above.

When the PSU selects 66 a specific vendor from the listing of available choices, in one embodiment, by selecting an icon of the specific vendor, the PSU is presented a page that allows the PSU to select 68 a specific group of products within the previously selected product type offered by the selected 66 vendor. In one embodiment, the selection 68 is made through a pull down menu that contains each product offered for sale by the selected vendor.

The act of selecting 68 a product by the PSU next causes database server 16 to link to a database of information for the selected vendor. The selected vendor's information database is not maintained as part of database server 16, rather, it is instead maintained by the vendor itself, for example within server 20 or provider system 22. The linking to the vendor database serves to provide database server 16 with a list of forms that are required and optional for the selected product. Linking, in one embodiment, takes place via Internet 18, and is directed by database server 16. In another embodiment, database server 16 directs a connection to provider system 22 over secure interface 24. The PSU takes no action to control the linking or connecting process.

The PSU may elect to either continue with the specific product offering that was selected 68 or, alternatively, to abandon pursuing that specific product in order to make a different 70 product selection. In the event the PSU chooses to select a different 70 policy or product, database server 16 automatically re-directs the PSU to select 68 a different product as previously described.

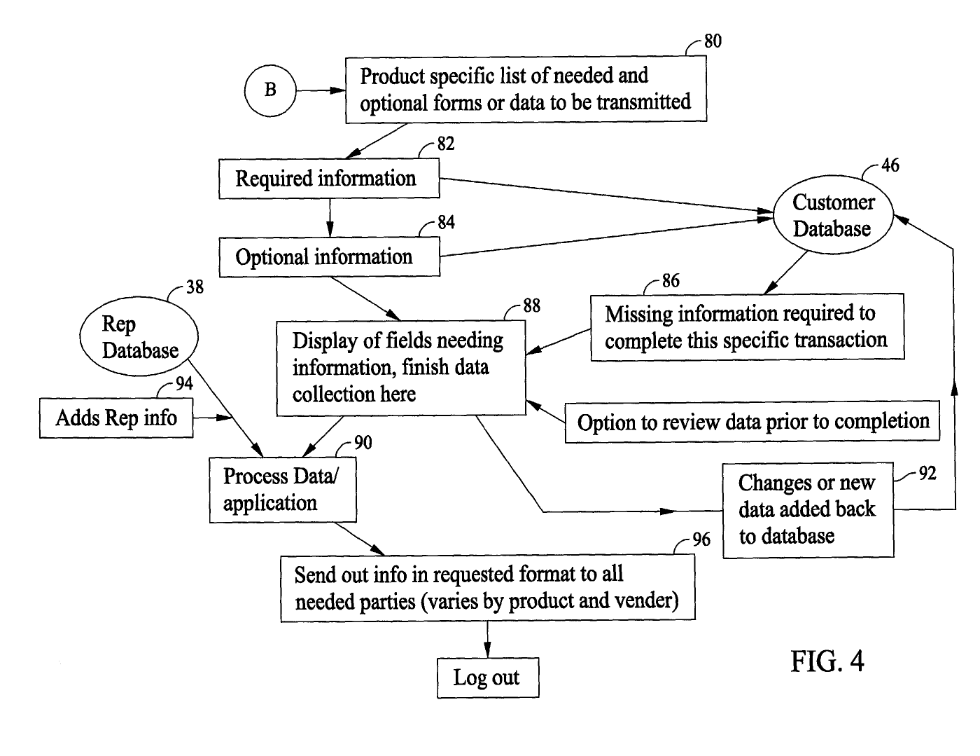

Referring to FIG. 4, in the event the PSU determines to continue with the policy or product selection 68 (shown in FIG. 3), then the PSU is directed 80 to a product specific list of needed and optional forms or data to be transmitted to secure the selected product for the client.

For certain product purchases there are one or more required forms for which required information 82 is needed for completion. For these products there also may be one or more optional forms for which at least some optional information 84 is needed for completion. Within each category, required or optional, individual forms may be selected. During the forms selection process, database server 16 is configured to, and without any intervention by the PSU, access a series of product databases within databases 14. In one embodiment, database server 16 forms a list of the information needed to complete all selected forms, both required and optional, and then accesses database 14 to determine if all the information in the list exists in the client file within customer database 46. In the event that customer database 46 includes all the information needed to complete the selected forms, database server 16 presents the PSU with a screen showing all of the forms that are currently able to be processed.

In the event that information needed for any of the forms is missing 86 from customer database 46, database server 16 is configured to present to the PSU a screen which displays 88 information fields that are missing from customer database 46 that is needed to complete the selected forms for the particular client. The information fields, in one embodiment allow the PSU to enter the missing information. The actual screen that is presented to the PSU is unique for the PSU's present situation, meaning that a listing of additional required information appears, depending upon the exact information requirements that remain unmet, and the data that is currently resident within customer database 46.

Once the PSU enters the missing information, the PSU may select to process 90 the data and apply for the financial product. In one embodiment, and without any intervention by the PSU, the additional information entered, including any changes, are added 92 to customer database 46. Therefore, customer database 46 is updated with all finalized information, based on the product application, and the data is date and time stamped for internal tracking purposes, billing purposes, and to create a permanent record of the transaction. The permanent record may be used for purposes of verifying compliance with applicable rules, regulations, and statutes that may govern the issuance of the type of financial product sold. The data may also be applicable to any future transactions between the PSU and the client.

Once all the information needed, both required and optional, is gathered, the PSU has an option of whether to review 94 the information which will be used to complete the required and optional product application forms. To complete processing of the application, a listing of forms that have been readied for final processing is presented to the PSU. Should the PSU choose to proceed, the forms will be generated which are used to apply for the selected financial product. Database server 16 is configured to access representative database 38 to generate 94 the personal identification needed to process the financial product at the vendor level (e.g. an agent insurance I.D. will be appended to the date and/or forms to be submitted). The personal identification procedure also works to ensure that the PSU will receive his or her commission.

Database server 16 is further configured to create and distribute 96 data and forms that will be used to direct, define, and ultimately to transmit and distribute the completed data and forms. Although referred to herein as forms, it is to be understood that forms encompasses all methods of getting the client information to the product vendor (provider). In alternative embodiments, the methods include, but are not limited to, formatting data streams to be received at server 20 or provider system 22 in a defined format, an encrypted E-mail to the product provider, a zip type file sent to the product provider, generation of actual paper forms to be sent to the provider, and the sending of a facsimile to the provider. Regarding the generation of paper forms, for products that require signed original or printed copies for the client, database server 16 completes the application forms for the selected product by meshing the client information in customer database 46 with requisite financial application forms for the vendor.

In one embodiment, after product application data has been sent to the provider of the financial product, database server 16 is configured to display an E-mail notification message on PSU computer 12. The E-mail notification message serves as an indication to the PSU that all of the data and/or forms have been processed and may be retrieved immediately through an e-mail system which is supported by database server 12. After the notification, PSU computer 12 is routed to the homepage 32, and the PSU may initiate another financial product purchase.

The above described methods and system configurations are better understood when their teachings are combined with the following displays which database server 16 causes to be displayed at PSU computer 12 (both shown in FIG. 1).

FIG. 5 is an example of a homepage 100, which includes a link to a virtual assistant process which is described above with respect to FIGS. 2-4. Upon selection of the virtual assistant link, system 10, and specifically database server 16, after a successful login by a PSU from a welcome page, causes a session profile to be started.

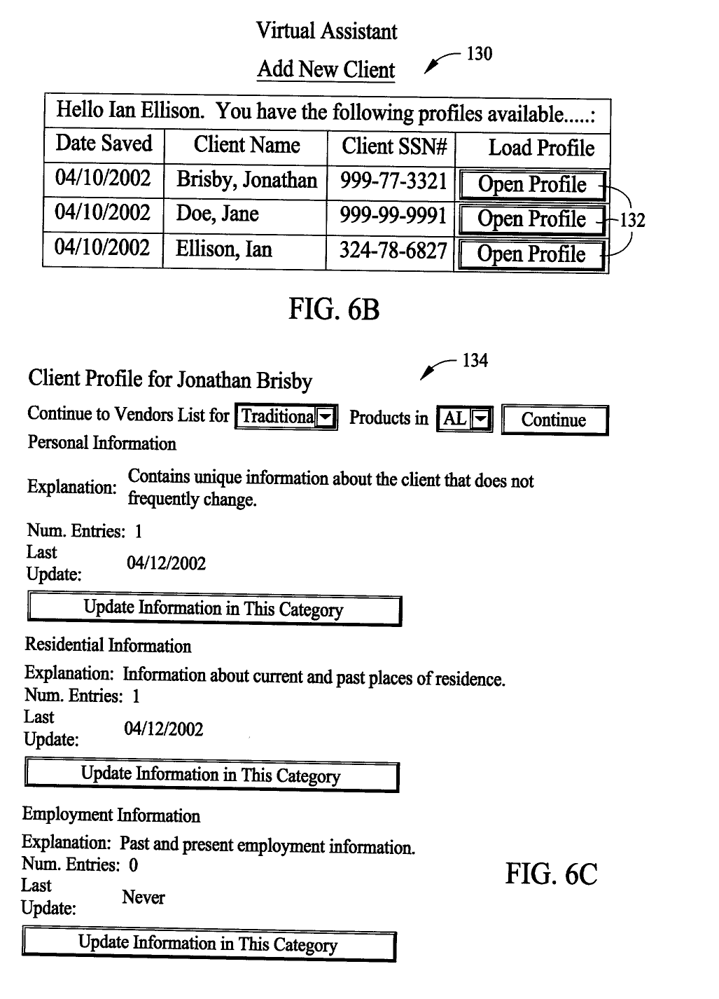

FIG. 6A is one example of an open profile screen 120 which is displayed at PSU computer 12 after a successful login. Screen 120 contains, in the embodiment shown, a profile for the client including name, address, and social security number. Screen 120 further includes a selectable link 122 which the PSU may select to update the client profile, for example, a simple address change. Screen 120 allows the PSU to select from a list of products the PSU is authorized to sell for each particular vendor, and further select the states where the PSU is authorized to sell each individual product. Screen 120 includes a link 124 where the PSU can select from the types of products they are authorized to sell, and a link for selecting a state for the product sale. In one embodiment, link 126 is configured to only allow selection of a state where the PSU is licensed.

FIG. 6B is a page 130 illustrating an alternative way for a PSU to select a client profile, that is, from a listing of current clients. Page 130 includes buttons 132 which can be selected by the PSU to display a profile for a client which can then be updated.

FIG. 6C is a page 134 illustrating a client profile for a client that was selecting, for example, from page 130 (shown in FIG. 6B). In the embodiment of page 134 shown, the PSU is able to make selections for updating different portions of the selected client profile, for example, personal information, residential information, and employment information. The PSU, from page 134 is able to select links for selecting the types of products they are authorized to sell and for selecting a state for the product sale, similar to the selections described in FIG. 6A. It should be understood that the embodiments shown in FIGS. 6A, 6B, and 6C are examples only. Many other combinations for selecting and updating client profiles utilizing selectable pages are thought to be within the scope of the description herein.

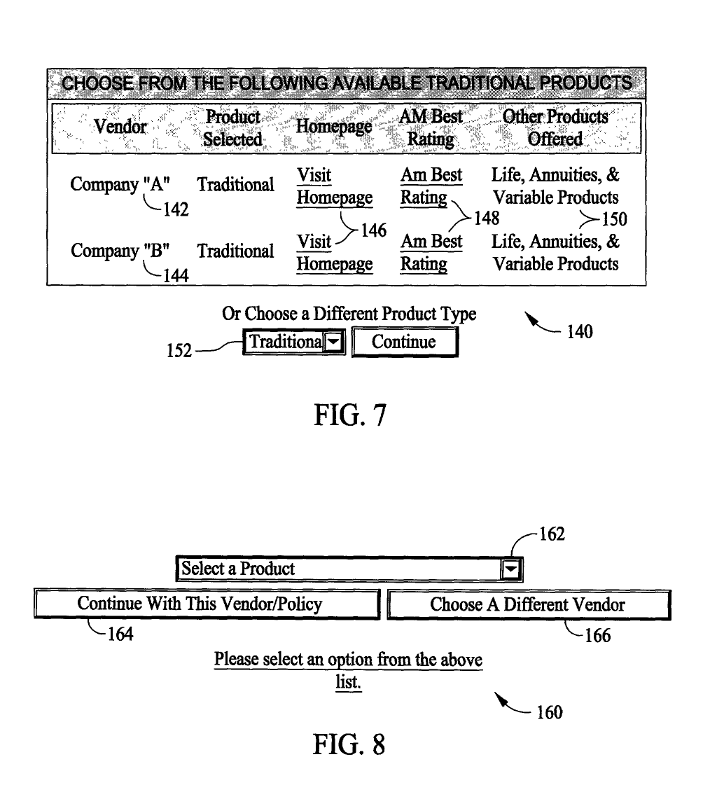

Upon completion of a product type selection and state from screen 120 or screen 134, the PSU is presented with a vendor selection screen 140, shown in FIG. 7. Screen 140 allows the PSU to select from which vendor they wish to purchase the previously selected product type, for example, by selecting one of Company “A” logo 142 or Company “B” logo 144. Other selections available from screen 140 include links 146 to each of the vendors home web sites and a selection 148 to view ratings on each of the vendors by well known rating services. Screen 140 further displays the types 150 of products offered by each of the individual vendors. Screen 140 further includes a link 152 where the PSU may choose to select a different product type, as described above in making a different 70 product selection (shown in FIG. 3).

FIG. 8 illustrates a product selection screen 160. In the embodiment shown, a pull down menu 162 allows the PSU to select a product from the previously selected vendor. For example, traditional products could include, but are not limited to, term life insurance of different terms (i.e. 10, 20, and 30 years), whole life insurance, and universal life insurance. Variable products may include a variable life insurance product, which typically includes securities purchases. Once a product is chosen, the PSU may select a link 164 which causes a continuation of the application process as above described for the selected product, from the selected vendor. A different vendor link 166, allows the PSU to go back and select a different vendor as described with respect to FIG. 7.

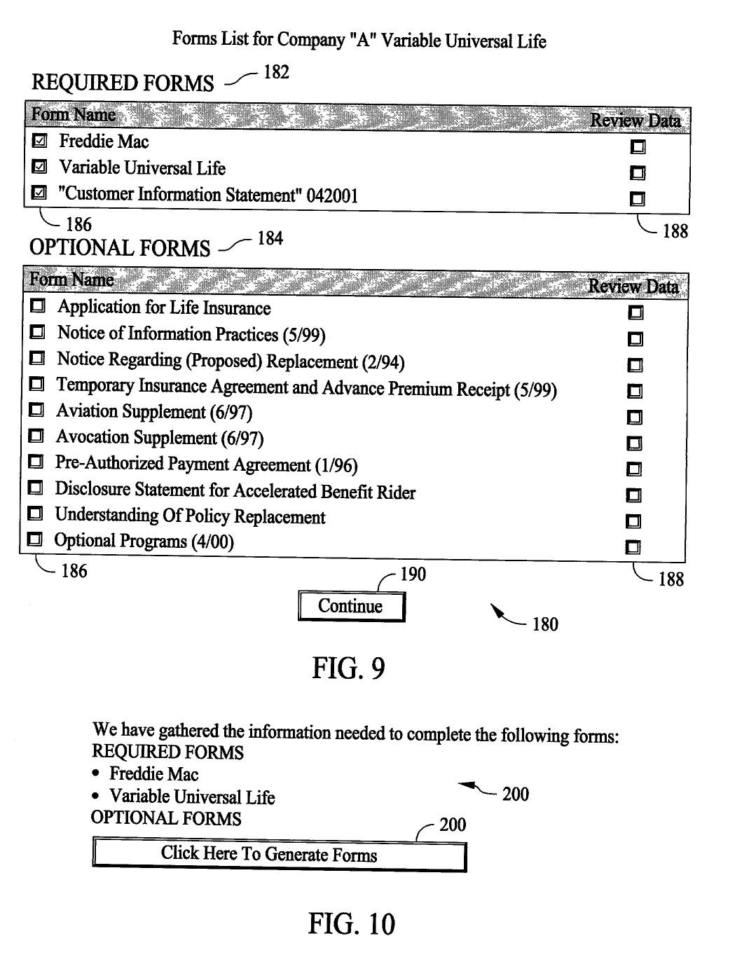

FIG. 9 is a required forms screen 180 which is displayed at PSU computer 12 upon selection of a vendor and a product as described above. Screen 180 includes a list 182 of required forms and a list 184 of optional forms which are used in applying for the selected financial product from the selected vendor. The PSU is able to select and deselect individual forms using check boxes 186 and review the data within database 14 (shown in FIG. 1) for each individual form by selection of review data check boxes 188. When continue button 190 is selected, a screen 200 (shown in FIG. 10) is generated. Screen 200 illustrates to the PSU which forms can be completed based upon the information available regarding the client in databases 14. Referring specifically to screen 200, database 14 currently contains all the client information needed to complete a “Freddie Mac 2000 Gen Am” form. By selecting button 202, information will be copied out of customer database 46 and formatted to be compatible with, for example, server 20 (shown in FIG. 1) (assuming for the moment that server 20 is the server for the vendor who has been selected by the PSU). The data is then sent to the server, and results in an application being generated for the selected financial product at server 20. As stated above, depending on the vendor, the application format may be in one of many forms, including fax, email, and hard copy.

The systems and methods described herein are considered to be unique in that the above described virtual assistant creates a single, central data repository of each and every form required by one or more financial institutions (i.e. vendors) to conduct their new business processes. While some new business processing systems are known to exist, those systems are best characterized as vendor specific. In other words, those systems are presently maintained under file management systems controlled uniquely by the financial institution for which the products were created. For example, Bank A may maintain its own mortgage application forms and customer information databases for Bank A loans, but Bank A will not have access to Bank B forms or databases, and vice versa. The outcome of the known systems is that a system user, for example, a PSU must maintain either resident file management systems or, alternatively, depend upon centralized database and file management systems of each and every vendor with which they conduct business. Therefore, the independent PSU must constantly enter and upload each data field for an existing client in order to complete the application for financial products of each and every product provider.

In contrast, database server 16 (shown in FIG. 1) may be linked to any financial services provider to complete all of the required “paperwork” for that provider for the purpose of applying for the intended product or service. Database server 16 automates the application process, since database server 16 is configured to constantly update the forms requirements for each financial services provider and to use the data within database 14 to complete all required forms for each selected product instantly and in a secure environment. The described system therefore avoids the need to re-enter confidential data each time a new product is applied for, even if the new product is offered by a different financial services provider. For example, a client may request life insurance, a mortgage, and a mutual fund from any one or more of the supported providers without a need to reenter certain data to for each application. Database server 16 completes the application process using data from database 14 and provides linkages needed to obtain the electronic forms from each financial services provider.

By constantly updating forms requirements for each of the financial services providers, or vendors, database server 16 eliminates the possibility of old or inappropriate forms being used for the application process. For example, database server is configured to extract the appropriate forms and supporting information, for example, a prospectus or similar advisory information, from server 20 (shown in FIG. 1) via the internet. A similar process is used with respect to provider system 22 and secure interface 24. The extracted forms are matched against profiles of both the PSU and their clients to ensure that the forms selected are appropriate to both the PSUs and their clients, as well as compliant with all regulatory provisions governing the sale of that product. For example, licenses of the PSU are a first evaluated before data from database 14 is formatted in a way so as to be processed into an application form. The license checking functions help assure compliance with state insurance laws, federal regulatory provisions and self-regulatory bodies.

After the forms and checking processes are completed, and the applications sent to the financial services provider, the completed forms may also be sent to a required entity. Many financial services products require the approval of advisory or regulatory bodies prior to the time of issuance. Database server is further configured with the appropriate regulatory entities based upon the profile of the PSU as well as the product that is being applied for. Highly regulated financial products typically require that certain disclosure information be provided. One example is a prospectus in the case of a securities product. Database server 16 maintains a log of all aspects of a transaction within database 14 to provide back-up documentation of all transactions. The logging provides an additional safeguard to the PSUs in the event of disputes between a PSU and any of their clients.

While the invention has been described in terms of various specific embodiments, those skilled in the art will recognize that the invention can be practiced with modification within the spirit and scope of the claims.

What is claimed is:

1. A database management system comprising:
a database server;
at least one database configured to be accessed by said database server;
at least one computer configured to access said database server via the internet; and
at least one server, said server configured to be accessed via at least one of the internet and a secure interface to said database server, said system configured to capture and store, in said database, financial and demographic information on clients collected by registered subscribers, said database server further configured to allow a registered subscriber to select any number of financial service providers and utilize the stored information to apply for any of a number of specific products offered by any selected financial services provider.

2. A database management system according to claim 1 wherein financial services comprises mortgages, insurance policies, annuities, mutual funds and property casualty insurance products.

3. A database management system according to claim 1 wherein said database server is configured to format the stored information in a format acceptable to the selected financial services provider.

4. A database management system according to claim 3 wherein said database server configured to format the stored information as at least one of a formatted data stream to be received at said server, an encrypted e-mail, an encrypted zip file, a fax document, and a paper form.

5. A database management system according to claim 1 wherein said database server is configured to request any additional financial and demographic information needed for a particular product application which is not already included within said database.

6. A database management system according to claim 5 wherein said database server is configured to store any newly entered financial and demographic information within said database.

7. A method for processing financial products using a database management system, the system including a database server and a database of client information, said method comprising:
logging in to the database management system;
selecting a client profile;
selecting a product;
determining if all information needed to complete an application form for the selected product is stored within the customer database for the selected client;
entering any information which is not stored within the customer database for the selected client;
generating an application for the selected product using the stored and entered information; and
storing the entered information for use in completing applications for additional financial products for other product types and other product vendors.

8. A method according to claim 7 wherein selecting a product further comprises:
selecting a product type; and
selecting a vendor for the product type.

9. A method according to claim 8 wherein selecting a product type comprises selecting one of traditional, variable, property and casualty, and loans.

10. A method according to claim 8 wherein selecting a vendor for the product type comprises displaying a list of vendors for the selected product type.

11. A method according to claim 7 wherein logging in to the database management system comprises:
determining whether the user is a paid subscriber; and
determining which products the subscriber is licensed to sell.

12. A method according to claim 11 wherein determining which products the subscriber is licensed to sell comprises determining in which states the user is licensed to sell which products.

13. A method according to claim 11 wherein determining whether the user is a paid subscriber comprises determining which product platforms a subscriber has subscribed to.

14. A method according to claim 7 wherein selecting a client profile comprises:
selecting a review profile and make update session;
updating the profile of the client; and
storing the updates in the database.

15. A method according to claim 7 wherein determining if all information needed to complete an application form for the selected product is stored comprises:
linking to a vendor database; and
receiving a list of required and optional forms for the selected product.

16. A method according to claim 15 further comprising:
displaying a list of the forms for the selected product;
selecting at least one of the displayed forms; and
determining if the information required to complete the selected forms is stored within the customer database.

17. A method according to claim 16 wherein entering any information not included within the customer database comprises:
displaying information fields for entry of the information for the selected forms which is not included in the customer database; and
entering the missing information.

18. A method according to claim 7 wherein generating an application for the selected product further comprises:
accessing a representative database to append identifying information for the PSU to the application; and
sending the application to the vendor.

19. A method according to claim 18 wherein sending the application to the vendor comprises any one or more of formatting a data stream to be sent to a vendor server, sending an encrypted E-mail to the vendor, sending a zip type file to the vendor, sending a facsimile to the vendor, and generating paper forms to be sent to the vendor

20. A method according to claim 19 further comprising generating a verification E-mail to be sent from the database server.

21. A computer configured as a database server, said computer configured for internet access and to control data written to and read from at least one database, said computer further configured to facilitate the storing, within the databases, information on clients collected by registered subscribers, the database including a listing of registered subscribers, said computer configured to allow registered subscribers to connect via the internet and select any number of product types and vendors for the product types and utilize the client information within the database to apply for any of a number of specific products offered by any selected vendor.

22. A computer according to claim 21 further configured to format the client information in a format acceptable for sending to the selected vendor as an application for a selected product.

23. A computer according to claim 22 further configured to generate the application as at least one of a formatted data stream to be received by the vendor, an encrypted e-mail sent to the vendor, an encrypted zip type file sent to the vendor, a fax document sent to the vendor, and a paper form to be mailed to the vendor.

24. A computer according to claim 22 further configured to request any information needed for a selected product application which is not stored within the database.

25. A computer according to claim 24 further configured to store within the database any information which is entered in response to the request for information.

26. A method of doing business, comprising:
storing, in a database, financial and demographic information for clients of registered subscribers, the information based upon at least one application for a financial services product, from at least one financial services provider;
retrieving, from the database, the financial and demographic information for a client which is required to complete an application for any additional financial services product offered through the registered subscriber, the financial services provider selected being the same or different than the provider for the previous application;
formatting the retrieved information in a format acceptable for transmission to the selected financial services provider; and
transmitting the formatted information to the financial services provider.

27. A method according to claim 26 farther comprising:
requesting additional financial and demographic information, should the stored information not be sufficient for completion of the additional application; and
storing the additional information in the database.

28. A method according to claim 26 wherein registered subscribers are unable to retrieve financial and demographic information for clients of other registered subscribers.

29. A method according to claim 26 further comprising:
requesting formatting updates from financial services providers; and
storing the updated formats in the database.
